(19) United States
(12) Patent Application Publication
(10) Pub. No.: US 2021/0262074 A1
(43) Pub. Date: Aug. 26, 2021

(54) MULTI NANO-PRECIPITATE STRENGTHENED AUSTENITIC STEEL

(71) Applicant: The Government of the United States of America, as represented by the Secretary of the Navy, Arlington, VA (US)

(72) Inventors: Colin A. Stewart, Alexandria, VA (US); Richard W. Fonda, Alexandria, DC (US); David J. Rowenhorst, Fairfax Station, VA (US); Paul K. Lambert, Columbia, MD (US)

(73) Assignee: The Government of the United States of America, as represented by the Secretary of the Navy, Arlington, VA (US)

(21) Appl. No.: 17/183,879

(22) Filed: Feb. 24, 2021

Related U.S. Application Data
(60) Provisional application No. 62/980,766, filed on Feb. 24, 2020.

(51) Int. Cl. C22C 38/58; C22C 38/06; C22C 38/42; C22C 38/44; C22C 38/46; C22C 38/48; C22C 38/50; C22C 38/34; C21D 6/00; C21D 6/02

(52) U.S. Cl. CPC C22C 38/58; C22C 38/06; C22C 38/42; C22C 38/44; C22C 38/46; C22C 38/48; B82Y 30/00; C22C 38/34; C21D 6/004; C21D 6/005; C21D 6/008; C21D 6/02; C22C 38/50

(57) ABSTRACT

Disclosed is an alloy having 7-30 wt. % manganese, 1-15 wt. % nickel, 1-10 wt. % aluminum, 1-8 wt. % copper, 0-15 wt. % chromium, 0-5 wt. % molybdenum, 0-3 wt. % vanadium, 0-3 wt. % titanium, 0-3 wt. % niobium, 0-2 wt. % silicon, 0-1 wt. % carbon, and balance of iron. A majority of the iron is γ-Fe. The alloy has β-NiAl precipitates and Cu-rich precipitates. At least 95 vol. % of the β-NiAl precipitates have a maximum dimension of 500 nm or less. The Cu-rich precipitates are at least 40 at. % copper. The alloy can be made by thermal processing steps without mechanical processing steps.

This application claims the benefit of U.S. Provisional Application No. 62/980,766, filed on Feb. 24, 2020. The provisional application and all other publications and patent documents referred to throughout this nonprovisional application are incorporated herein by reference.

### TECHNICAL FIELD

The present disclosure is generally related to steel alloys.

### DESCRIPTION OF RELATED ART

In ferritic steels (including tempered martensitic alloys), Cu precipitates form with a metastable BCC structure within the BCC ferritic matrix and then later transform into incoherent FCC particles [7]. These Cu precipitates act as powerful strengtheners, producing yield strength increases of ˜200 MPa [8,9]. The exact mechanism is not well understood, but has been attributed to moving dislocations transforming the metastable BCC structure of the Cu precipitate into one resembling FCC [8], modulus misfit strengthening between BCC Fe and BCC Cu [7], or dislocation pileup at the incoherent interface of the FCC Cu precipitates [7,8]. Intermetallic β-NiAl (B2) has also been used to strengthen ferritic steels, forming ordered coherent nano-precipitates that provide yield strength increases on the order of 100-500 MPa [10,11]. Combined, both Cu and β-NiAl exhibit an intriguing synergy in ferrite, whereby the formation of one phase both promotes the formation and accelerates the precipitation hardening kinetics of the other [9,12,13]. Together, these two precipitate phases can increase the yield strength of the alloys by 400-500 MPa with minimal loss in ductility.

The precipitation behavior of Cu and β-NiAl within Austenitic alloys is fundamentally different from that in ferritic systems, and is also not as well understood. FCC copper precipitates form coherently within the FCC Austenite matrix and are much less effective strengtheners than in ferrite [14,15]. The ordered BCC β-NiAl phase forms intragranularly as nano-scale platelets, on the order of 100-200 nm diameter and ˜20 nm thickness, with a Kurjumov-Sachs (K-S) orientation relationship with the FCC matrix [16]. These precipitates serve as potent strengtheners that can generate yield strengths in the range 1000-1300 MPa [16-18].

Ni and Mn are the primary substitutional elements for stabilizing the Austenite across a wide range of temperatures and strains [19]. Ni is more effective, but is roughly an order of magnitude more costly than Mn [20]. There are also different precipitation behaviors of β-NiAl in Ni-stabilized [16,21] and Mn-stabilized [18,22-24] Austenitic steels. The Mn-containing alloys appear to require rolling steps prior to ageing to precipitate the fine intragranular β-NiAl platelets along dislocations, whereas the Ni-stabilized alloys do not [16,22,25], suggesting a higher barrier to nucleation of the β-NiAl precipitates in the Mn-stabilized steels. While there is comparatively little published literature on combining Cu and β-NiAl precipitates to strengthen Austenitic steels, it has been reported that Cu additions refine the distribution of β-NiAl and thus increase the alloy strength [26]. This indicates a possible synergy between these two precipitate types that reduces the β-NiAl nucleation barrier, similar to what was reported in ferritic alloys.

### BRIEF SUMMARY

Disclosed herein is an alloy comprising 7-30 wt. % manganese, 1-15 wt. % nickel, 1-10 wt. % aluminum, 1-8 wt. % copper, 0-15 wt. % chromium, 0-5 wt. % molybdenum, 0-3 wt. % vanadium, 0-3 wt. % titanium, 0-3 wt. % niobium, 0-2 wt. % silicon, 0-1 wt. % carbon, and balance of iron. A majority of the iron is γ-Fe. The alloy comprises β-NiAl precipitates, wherein at least 95 vol. % of the β-NiAl precipitates have a maximum dimension of 500 nm or less. The alloy comprises Cu-rich precipitates comprising at least 40 at. % copper.

Also disclosed herein is method comprising: providing a mixture of elements comprising 7-30 wt. % manganese, 1-15 wt. % nickel, 1-10 wt. % aluminum, 1-8 wt. % copper, 0-15 wt. % chromium, 0-5 wt. % molybdenum, 0-3 wt. % vanadium, 0-3 wt. % titanium, 0-3 wt. % niobium, 0-2 wt. % silicon, 0-1 wt. % carbon, and balance of iron; forming an alloy from the mixture; heating the alloy to a temperature that causes formation of γ-Fe; cooling or quenching the alloy to retain the γ-Fe at room temperature; and heat treating the alloy through one or more ageing steps to form β-NiAl precipitates and Cu-rich precipitates. At least 95 vol. % of the β-NiAl precipitates have a maximum dimension of 500 nm or less. The Cu-rich precipitates comprise at least 40 at. % copper.

### BRIEF DESCRIPTION OF THE DRAWINGS

A more complete appreciation will be readily obtained by reference to the following Description of the Example Embodiments and the accompanying drawings.

FIGS. 1-5 show Thermo-Calc predictions of (FIGS. 1-4) phase fraction vs. temperature for the “Base” Fe-17.7Mn-4.7Cr-0.48C wt. % alloy and various modifications, and (FIG. 5) an isothermal-isoconcentrate phase diagram of the Base compositions with changing Al and Ni contents at 580° C.

FIG. 6 shows Vickers microhardness and corresponding estimated yield strength [32] of the Base-10Ni-5Al-4Cu wt. %, Base-10Ni-5Al-0Cu wt. %, and Base-0Ni-0Al-4Cu wt. %, alloys (designated Base-10-5-4, Base-10-5-0, and Base-0-0-4, respectively) for various ageing times at 580° C.

FIG. 7 shows reconstructed APT dataset of needle tip (T3), with isoconcentrate surfaces outlined for Ni+Al=20 at % (top right), Cu=5 at % (bottom left), and Cr=12 at % (bottom right). Observed feature properties are given in Table 3, and selected locations of apparent co-location between the phases are shown in insets (a-d).

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

To achieve an industry-scalable modern steel, the use of integrated computational materials engineering (ICME) [1] is essential for an agile alloy design process. The present study focuses on the application of ICME tools to design and develop a new family of fully Austenitic (γ-Fe FCC matrix), high-strength steels that exhibit the excellent ductility typically associated with Austenitic alloys. Commercially available Austenitic steels can only achieve yield strengths in the general range of σ_{y}=170-380 MPa [2-5]. Since solid-solution strengthening is much less effective in Austenitic steels than in ferritic steels (which have an a-Fe BCC matrix) [6,7], precipitation hardening was pursued as the primary strengthening mechanism.

Disclosed herein is an Austenitic steel (face centered cubic crystal structure) which is stabilized using a combination of C, Mn, Cu, and Ni and which is strengthened upon age heat treatment by the formation of a hierarchical structure of multiple precipitate phases, including intermetallic β-NiAl (B2 ordered body centered cubic crystal structure) and Cu precipitates, and optionally a carbide phase (for example the M₂₃C₆ (M=Mn, Cr, Mo) or the MC (M=V, Ti, Nb, Mo) carbides). These precipitates are achievable on the nano-scale for enhanced hardening, and can be tailored to obtain the desired mechanical properties and cost. The result is a high-strength Austenitic steel of lower-cost than Ni-based alternatives.

The steel (Fe-base alloy) is comprised of an Austenitic-structure matrix (face centered cubic crystal structure) stabilized by C, Ni, Cu, and Mn additions, with greater Mn content than Ni by weight for cost-effectiveness. Upon aging heat treatment (for example, times in the range of 1-24 hours at temperatures in the range 400-750° C.), multiple additional material phases precipitate, including a Cu-rich FCC phase, ordered intermetallic β-NiAl (B2 structure), and optionally carbide phase(s) (M₂₃C₆, MC). These precipitates are achievable on the nano-scale (on the order of 1-100 nm length) for increased material hardness. Because this nano-scale precipitation can be achieved without the use of mechanical processing steps prior to age heat treatment (e.g. cold rolling), further cost savings may be achieved. The discovery was made in a steel of approximate composition (percent by weight): Fe-17.7Mn-4.7Cr-0.48C-10Ni-5Al-4Cu. The alloy may contain the weight percentages of the elements in the Table 1, including any value within these ranges. The alloy may contain additional elements not listed in Table 1, with the balance of iron reduced accordingly.

TABLE 1
Elemental composition

| | weight % | | | | | | | | | | | |
|---|---|---|---|---|---|---|---|---|---|---|---|---|
| | Fe | Mn | Cr | C | Al | Ni | Cu | V | Ti | Nb | Mo | Si |
| Lower bound | bal | 7 | 0 | 0 | 1 | 1 | 1 | 0 | 0 | 0 | 0 | 0 |
| Intermediate | bal | 10 | 4 | 0.1 | 3 | 5 | 2 | 0.3 | 0.3 | 0.3 | 0.5 | 0.2 |
| Intermediate | bal | 17 | 6 | | 4 | 7 | 3 | | | | | |
| Intermediate | bal | 19 | | | 6 | 11 | 5 | | | | | |
| Intermediate | bal | 25 | | | 8 | | 7 | | | | | |
| Upper bound | bal | 30 | 15 | 1 | 10 | 15 | 8 | 3 | 3 | 3 | 5 | 2 |

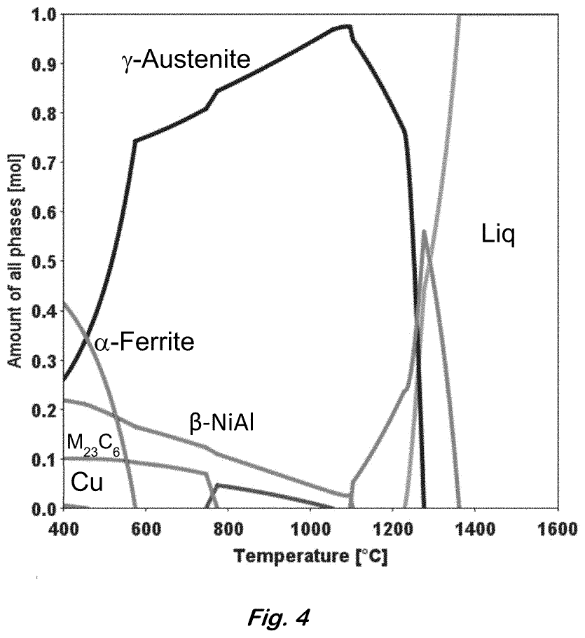

The alloy may be made solely by thermal processing steps. Mechanical and thermomechanical processing, such as rolling, drawing, and peening, is optional. The elements are alloyed by any method for alloying metals, such as casting or arc-melting. The alloy is then heated to a temperature that converts the iron to γ-Fe. For example, the heating may be to 1000° C. under argon. FIG. 4 provides guidance for selecting the temperature. The alloy is then cooled or quenched to retain the γ-Fe phase. The alloy is then reheated to an intermediate temperature (for example, 600° C.) and then cooled or quenched to promote the precipitation of β-NiAl precipitates and Cu-rich precipitates. One or more of these ageing treatments may be applied to achieve the desired precipitation. This process can produce β-NiAl precipitates, Cu-rich precipitates and optionally M₂₃C₆ (M=Mn, Cr, Mo) or MC (M=V, Nb, Ti, Mo).

The sizes of the β-NiAl precipitates are such that at least 95 or 98 vol. % of the β-NiAl precipitates have a maximum dimension of 500 nm or less or 100 nm or less. As used herein “maximum dimension” is equivalent to a maximum caliper dimension and means the greatest length that can be measured for the precipitate between any two points on the precipitate surface. No length measurement of the precipitate is larger than this size no matter what direction that length is measured in. The vol. % of the precipitates refers to the vol. % of all of the β-NiAl precipitates in the alloy. None are excluded to make this calculation. Thus, very little, if any, of the β-NiAl precipitates are in the form of stringers, which can be detrimental to the mechanical properties of the steel [24]. The Cu-rich precipitates are at least 40 at. % copper.

The alloy may have a microhardness of at least 300 HV or 490 HV. The yield strength, which may be measured or estimated from the microhardness, may be at least 550 MPa, 689 MPa, or 1200 MPa.

The following examples are given to illustrate specific applications. These specific examples are not intended to limit the scope of the disclosure in this application.

### EXAMPLES

Thermodynamic calculations of phase equilibria in potential alloys were conducted using the 2020a release of the Thermo-Calc software (Thermo-Calc, Stockholm, Sweden) with the TCFE9 thermodynamic database. To model the β-NiAl phase, the “B2_BCC” phase description included in TCFE9 was enabled, and a new composition set was defined with major sublattice constituents (Ni,Fe)(Al,Mn)(Va) due to high solubility for Fe and Mn in β-NiAl [27-29]. A baseline Austenitic composition of Fe-17.7Mn-4.7Cr-0.48C wt. % was selected from prior experimental studies [30,31]. Promising compositional modifications (Table 2) containing Ni+Al (Base-10-5-0), Cu (Base-0-0-4), and Ni+Al+Cu (Base-10-5-4) were identified with the guidance of Thermo-Calc modeling. These compositions were prepared by arc-melting high-purity (>99.9%) elemental constituents to produce ˜40 g button ingots in an ultra-high purity argon static atmosphere. The ingots were melted and inverted six times to ensure alloy homogeneity.

TABLE 2
Nominal and experimentally measured alloy compositions in this study (wt. %)

| Alloy | | Fe | Mn | Cr | C | Ni | Al | Cu |
|---|---|---|---|---|---|---|---|---|
| Base | Nominal | bal. | 17.7 | 4.7 | 0.48 | | | |
| Base-0-0-4 | Nominal | bal. | 17.7 | 4.7 | 0.48 | | | 4.0 |
| | SEM EDS 20 kV | bal. | 16.7 | 4.6 | * | | | 4.1 |
| Base-10-5-0 | Nominal | bal. | 17.7 | 4.7 | 0.48 | 10.0 | 5.0 | |
| | SEM EDS 20 kV | bal. | 18.2 | 4.5 | * | 9.8 | 4.4 | |
| Base-10-5-4 | Nominal | bal. | 17.7 | 4.7 | 0.48 | 10.0 | 5.0 | 4.0 |
| | SEM EDS 20 kV | bal. | 17.8 | 4.6 | * | 9.8 | 4.6 | 4.2 |
| | APT (all tips) | bal. | 17.5 | 5.3 | 0.42 | 10.2 | 6.2 | 4.1 |

* Carbon content not measured by SEM EDS.

After melting, the ingots were sectioned, wrapped in Ta foil as an oxygen getter, and encapsulated in evacuated quartz ampoules backfilled with ˜34 kPa of UHP Ar. Samples were solutionized at 1000° C. for 12 h followed by 1100° C. for 96 h, which was calculated to be in the fully Austenitic region of the alloys, above the solvus of any carbides, Cu, or β-NiAl particles. The samples were water-quenched after the 1100° C. solutionizing treatment then re-encapsulated and aged at 580° C. for a variety of times, followed by water quenching.

After heat-treatment, the samples were sectioned, mounted in epoxy, and polished. Microhardness was carried out in a LECO AMH55 automatic hardness tester (LECO Corp., St. Joseph Mich.) with a Vickers-type indenter at 500 gf load and 15 second dwell time. Reported microhardnesses are the average of 20 measurements from each sample. Estimated values for yield strength (σ_{y}) were calculated from these experimental Vickers hardness values (HV) based on the empirical relation observed between these parameters in Austenitic alloys by previous authors [32].

The underlying nano-scale microstructures were analyzed by atom-probe tomography (APT) using a Cameca 4000× Si™ local electrode atom probe (LEAP) (Cameca, Gennevilliers Cedex, France) with a 355 nm ultraviolet pulsed laser, 40 K specimen base temperature, 30 pJ laser pulse energy, 500 kHz pulse repetition rate, and a detection rate of 0.05 ions per pulse (0.5%). Specimens for APT were prepared using standard lift-out and milling procedures [33-35] in a ThermoFisher Nova 600 NanoLab DualBeam™ focused ion beam/scanning electron microscope (FIB/SEM). Data reconstruction and analysis was done with Cameca Integrated Visualization and Analysis Software (IVAS) version 3.8.2. The β-NiAl, FCC—Cu, and M₂₃C₆ precipitates were delimited by isoconcentration surfaces of 20 at. % (Ni+Al), 5 at. % Cu, and 12 at. % Cr respectively, employing a voxel size of 1.0 nm, a delocalization distance of 3.0 nm laterally and 1.5 nm along the analysis direction, and a confidence sigma parameter of 1.0 for effective noise suppression [36]. These isoconcentration surface values were chosen to faithfully represent the extent of the precipitates and are consistent with those used in prior APT studies on similar alloys [9,15,37-43].

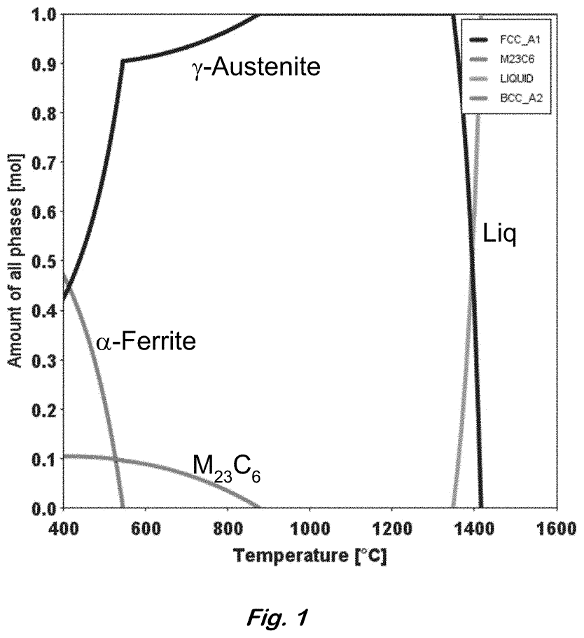

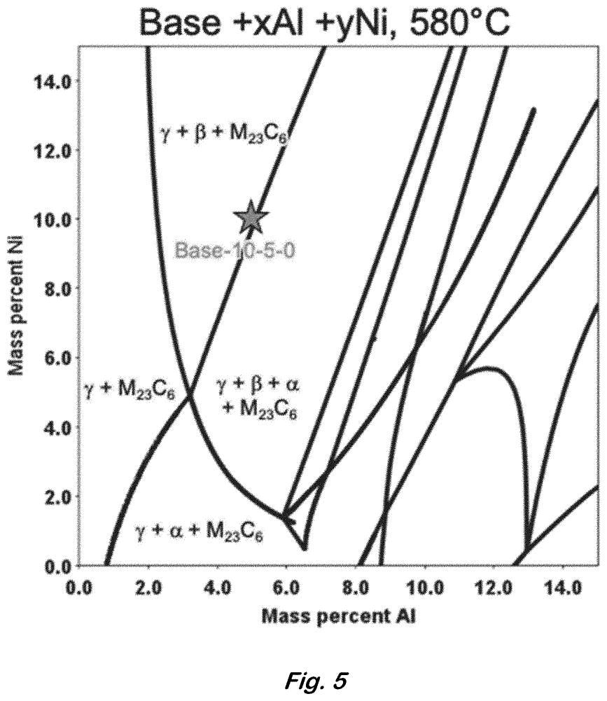

Results of the initial Thermo-Calc modeling are shown in FIGS. 1-5, with FIGS. 1-4 showing the phase fractions vs. temperature for the Base alloy and compositional modifications, and FIG. 5 showing an isothermal-isoconcentrate (ITIC) phase diagram of the Base alloy at 580° C. as a function of Ni and Al contents in place of the solvent Fe. The calculations for the Base alloy (FIG. 1) show a predominantly Austenitic alloy with M₂₃C₆ carbides (M=Mn, Cr) and a ferrite transformation at temperatures below 540° C.

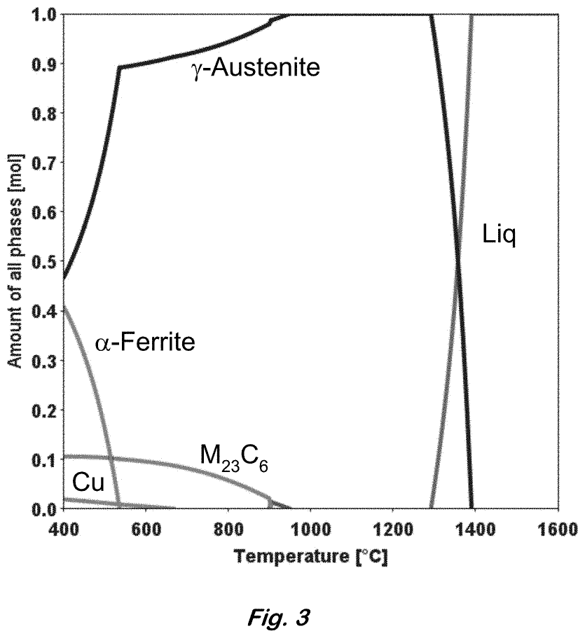

The ITIC phase diagram in FIG. 5 shows the effect of Ni+Al modifications on the formation of the β-NiAl phase. Within the desired phase field containing γ-Austenite, β-NiAl, and some amounts of carbide phase from the Base alloy, the Base-10-5-0 composition is marked with a star, and the expected phases as a function of temperature for that alloy are modeled in FIG. 4. This calculation predicts that the Base-10-5-0 alloy contains 17 vol. % of β-NiAl phase at 400° C., decreasing continuously with increasing temperature to a solvus at ˜920° C. This Base-10-5-0 composition was selected since it is predicted to form a reasonable amount of the β-NiAl phase; greater Ni contents would be costlier [20], and greater Al contents may lead to processing issues in industrial-scale melts [44]. FIG. 3 demonstrates that the Base-0-0-4 alloy (with Cu additions) has comparable calculated phase stability to the Base alloy, but with an additional 2 vol. % FCC—Cu at 400° C., decreasing with temperature to a solvus at ˜680° C. FIG. 4 shows the calculated phase stability for the Base-10-5-4 alloy, which has combined Ni+Al+Cu modifications. This alloy is calculated to have more β-NiAl than the Base-10-5-0 composition, 22 vol. % at 400° C., and a higher solvus at 1100° C. Very little FCC—Cu phase is predicted, <1 vol. % at 400° C., with a solvus temperature ˜450° C. While all of these alloys are predicted to have a low-temperature α-ferrite phase, alloys Base-10-5-0 and Base-10-5-4 are also calculated to have a high-temperature δ-ferrite phase above ˜1100° C. For these reasons, a solutionizing temperature of 1100° C. was selected to dissolve the carbide, Cu, and β-NiAl phases, and 580° C. was selected as the ageing temperature for precipitation of β-NiAl and/or FCC—Cu precipitates.

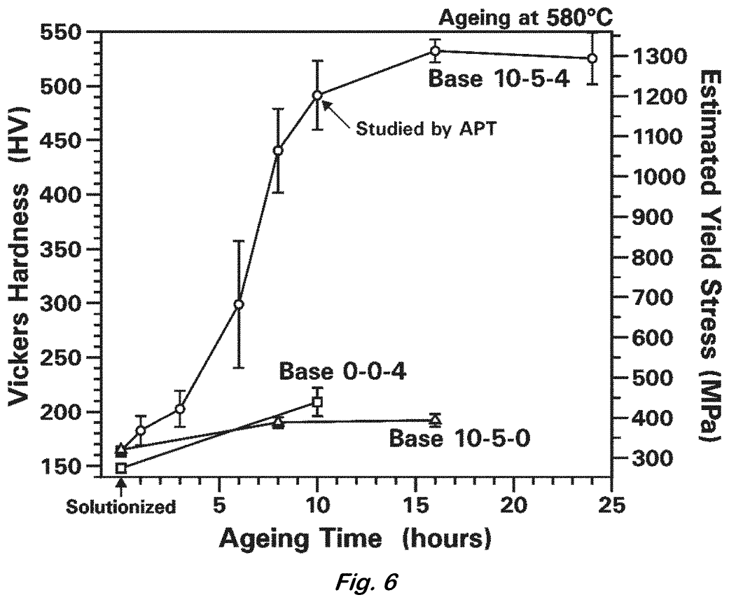

The Austenitic nature of the alloys was confirmed by X-ray diffraction (results not shown). Vickers microindentation was used as the primary indicator for the presence of strengthening precipitates due to their nano-scale. FIG. 6 displays the microhardness evolution for the three compositional modifications during ageing at 580° C. In the as-solutionized condition, the alloys have a similar ˜160 HV microhardness. Upon ageing, negligible hardening of the Base-10-5-0 alloy was observed, with only slightly more hardening in the Base-0-0-4 alloy. However, the combined Ni+Al+Cu modified Base-10-5-4 alloy exhibited significant hardening of +330 HV after 10 h at 580° C.

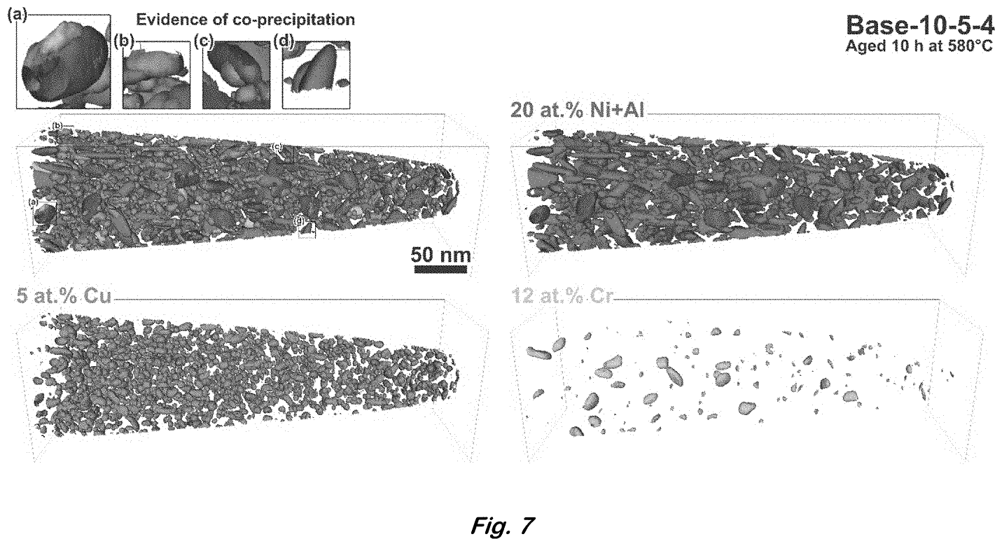

The near-peak aged condition of the Base-10-5-4 alloy, 10 h at 580° C., was studied by APT and is displayed in FIG. 7, showing the constituent nano-scale β-NiAl platelets, FCC—Cu, and Cr-rich M₂₃C₆ carbides. The average volume fraction, volume-equivalent radius (VER), and number density of each phase was measured from three different APT analyses and are reported in Table 3. The VER is calculated from the number of atoms contained within each phase's isoconcentration surface [37-39,45], assuming a detection efficiency of 0.5. The volume fraction is the ratio of the total number of atoms contained within the precipitates to the total number of atoms collected, and the average atomic density of each phase was calculated from their respective lattice parameters [46-48]. The number density is calculated directly from the number of precipitates in the analyzed volume, with precipitates fully contained in the reconstruction volume being counted as whole precipitates and those that intersect the surface of the reconstructed volume counted as half precipitates [49]. Compositional analysis of the precipitates was performed with the proximity histogram (proxigram) method [50,51], with the core compositions of each phase (Table 3d-f) determined from the plateau concentrations (except for the Cu phase, which did not exhibit a plateau in the proxigram, as discussed below) of their respective proxigrams. Corresponding predictions from Thermo-Calc are also reported in Table 3. These represent the predicted equilibrium thermodynamic calculations and do not predict time-dependent factors like particle size or number density.

TABLE 3
Material parameters of three reconstructed APT datasets (T1-
T3) from Base-10-5-4 alloy after aging at 580° C. for
10 h (FIG. 7), compared with Thermo-Calc calculations. The
numbers in parentheses represents the uncertainty in the
last digit reported according to statistical counting errors
[59, 60]. Approximate sizes of the datasets were 3.5E7,
3.9E7, and 1.5E8 ranged ions for (T1-3) respectively

| (a) | Volume percent | | | | |
|---|---|---|---|---|---|
| Phase | (T1) | (T2) | (T3) | All tips | ThermoCalc |
| Matrix (γ) | 81.0 | 81.0 | 78.2 | 79.1 | 75.6 |
| FCC-Cu | 5.1 | 5.5 | 5.5 | 5.5 | 0.0 |
| β-NiAl | 13.6 | 13.1 | 15.9 | 15.1 | 16.6 |
| M₂₃C₆ | 0.2 | 0.4 | 0.3 | 0.3 | 7.8 |

| | |
|---|---|
| (b) | Average equivalent radius (nm) |

| Phase | (T1) | (T2) | (T3) | All tips |
|---|---|---|---|---|
| FCC-Cu | 2.6 | 2.7 | 2.7 | 2.7 |
| β-NiAl | 3.1 | 2.7 | 3.1 | 3.0 |
| M₂₃C₆ | 1.7 | 1.8 | 1.7 | 1.9 |

| | |
|---|---|
| (c) | Number density (m⁻³) |

| Phase | (T1) | (T2) | (T3) | All tips |
|---|---|---|---|---|
| FCC-Cu | 3.8E+23 | 3.6E+23 | 3.5E+23 | 3.6E+23 |
| β-NiAl | 2.1E+23 | 2.1E+23 | 2.0E+23 | 2.0E+23 |
| M₂₃C₆ | 3.3E+22 | 3.0E+22 | 2.6E+22 | 2.8E+22 |

| (d) | β-NiAl core composition (at. %) | | | | | | |
|---|---|---|---|---|---|---|---|
| Sample | Fe | Mn | Cr | C | Ni | Al | Cu |
| (T1) prox. | 4 | 8 | 0 | 1 | 43 | 39 | 4 |
| (T2) prox. | 4 | 8 | 0 | 1 | 44 | 39 | 4 |
| (T3) prox. | 4 | 8 | 0 | 1 | 44 | 39 | 4 |
| All tips | 4 | 8 | 0 | 1 | 44 | 39 | 4 |
| ThermoCalc | 13 | 13 | 0 | 0 | 34 | 31 | 9 |
| (e) | FCC-Cu core composition (at. %) | | | | | | |
| Sample | Fe | Mn | Cr | C | Ni | Al | Cu |
| (T1) prox. | 8 | 9 | 1 | 0 | 9 | 13 | 61 |
| (T2) prox. | 7 | 9 | 1 | 0 | 8 | 12 | 64 |
| (T3) prox. | 13 | 9 | 1 | 0 | 7 | 12 | 59 |
| All tips | 11 | 9 | 1 | 0 | 8 | 12 | 60 |
| ThermoCalc | — | — | — | — | — | — | — |
| (f) | M₂₃C₆ core composition (at. %) | | | | | | |
| Sample | Fe | Mn | Cr | C | Ni | Al | Cu |
| (T1) prox. | 13 | 12 | 56 | 15 | 1 | 2 | 0 |
| (T2) prox. | 7 | 12 | 59 | 20 | 1 | 1 | 0 |
| (T3) prox. | 13 | 12 | 53 | 19 | 2 | 2 | 0 |
| All tips | 11 | 12 | 54 | 19 | 2 | 2 | 0 |
| ThermoCalc | 18 | 22 | 39 | 21 | 0 | 0 | 0 |

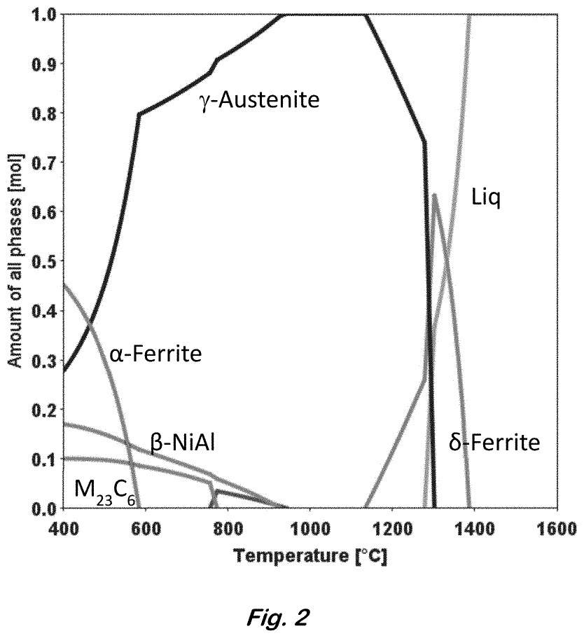

While Thermo-Calc predicts that ageing the Base-10-5-0 alloy will produce appreciable β-NiAl precipitation (FIG. 2), almost no hardening relative to the as-solutionized condition was observed (FIG. 6). This lack of hardening implies that in the Base Austenite composition, the chosen Ni+Al additions are insufficient to form β-NiAl precipitates from ageing alone. This is consistent with previous studies [18,22] that suggested a higher nucleation barrier for the precipitation of β-NiAl in Mn-stabilized Austenitic steels that required cold work (rolling) to overcome.

The barrier to β-NiAl precipitation can be overcome with the addition of Cu. A pronounced synergy was observed in the Base-10-5-4 alloy, where precipitates of β-NiAl, Cu, and M₂₃C₆ combine to increase the microhardness by 330 HV after ageing for 10 h at 580° C. This increase matches the observed improvement from β-NiAl precipitation in Ni-stabilized steels by other authors [16]. Because similar hardening was not observed in the Base-10-5-0 or Base-0-0-4 alloys, this demonstrates that Cu facilitates the nucleation of the β-NiAl precipitates to give rise to that hardening. This synergy is supported by APT analyses, which appear to show co-localization of the Cu and β-NiAl phases (FIG. 7). Additional analysis from shorter ageing times is needed to reveal the formation mechanism and sequence of these synergistic precipitates. Lastly, the carbide phase seen in APT exhibits a stoichiometry matching the M₂₃C₆ phase (Table 3f) as predicted by Thermo-Calc (FIG. 4), although the small amount of this phase likely does not contribute significantly to age hardening.

The Thermo-Calc predictions provide useful guidance for this ICME alloy design approach, but it is important to note the differences between those predictions and the experimental results to support improvements in the databases. One of the more important differences is in the stability of Austenite present at low temperatures. While FIGS. 1-5 predict a significant amount of ferrite in these alloys at low temperatures, present experiments and other studies [30] indicate that these compositions are fully Austenitic. This supports the observations of other authors (using an older TCFE7 database) [52] that the stability of Austenite is under-represented in the iron database.

The apparent composition of the FCC—Cu precipitates, as measured by APT, is only ˜60 at. % Cu, much lower than that reported in other steel systems or suggested by the Fe—Cu binary phase diagram [15,53,54]. This is likely due to the well-documented local magnification effect in APT for Fe—Cu systems [55-57]. Thermo-Calc predicts this phase to dissolve at ˜450° C. in the Base-10-5-4 alloy, but Cu also incorporates into β-NiAl. The incorporation of Cu in β-NiAl is experimentally measured by APT to be ˜4 at. %, while Thermo-Calc predicts a much higher 9 at. % concentration (Table 3d). This discrepancy is consistent with the predicted lack of FCC—Cu precipitates in Base-10-5-4 at 580° C. (FIG. 4), despite clear experimental evidence of their presence (FIG. 7). Additionally, the Thermo-Calc results overpredict Fe and Mn solubility in β-NiAl, perhaps tying in to the small overprediction of β-NiAl volume fraction: 17% calculated vs. 15% by APT. Despite these discrepancies, the use of CALPHAD was effective in rapidly identifying a series of fully Austenitic alloys that can be aged to produce the desired β-NiAl+Cu nano-precipitates.

Overall, this study has demonstrated the promise of combined Cu+β-NiAl nano-precipitates to strengthen Austenitic steels, for which a paucity of data presently exists [58]. The APT data of the near-peak aged condition presented here directly demonstrate the formation of a complex nano-structure that provides significant hardening to the Austenitic matrix upon ageing.

Obviously, many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

### REFERENCES

1. W. Xiong, G. B. Olson, MRS Bull. 40 (2015) 1035-1044.
2. W.-G. Guo, S. Nemat-Nasser, Mech. Mater. 38 (2006) 1090-1103.
3. International Trade Winds LLC, AL-6XN Alloy Data Sheet, (2015). http://www.itwmetals.com.br/data/content/AL-6XN_DS_BRAZIL_English_da0oLy.pdf (accessed 21 Mar. 2020).
4. Lenntech, Stainless Steel 304, (2020). https://www.lenntech.com/stainless-steel-304.htm (accessed 21 Mar. 2020).
5. United Performance Metals, Stainless 316, 316L, 317, 317L, (n.d.). https://www.upmet.com/sites/default/files/datasheets/316-3161.pdf (accessed 21 Mar. 2020).
6. Y. Jiang, Q. Gao, H. Zhang, X. Zhang, H. Li, Z. Liu, C. Liu, Mater. Sci. Eng. A 748 (2019) 161-172.
7. J.-S. Wang, M. D. Mulholland, G. B. Olson, D. N. Seidman, Acta Mater. 61 (2013) 4939-4952.
8. M. E. Fine, D. Isheim, Scr. Mater. 53 (2005) 115-118.
9. Z. B. Jiao, J. H. Luan, M. K. Miller, C. Y. Yu, C. T. Liu, Sci. Rep. 6 (2016) 21364.
10. Z. B. Jiao, J. H. Luan, M. K. Miller, C. Y. Yu, C. T. Liu, Acta Mater. 84 (2015) 283-291.
11. Z. K. Teng, M. K. Miller, G. Ghosh, C. T. Liu, S. Huang, K. F. Russell, M. E. Fine, P. K. Liaw, Scr. Mater. 63 (2010) 61-64.
12. Z. Zhang, C. T. Liu, M. K. Miller, X.-L. Wang, Y. Wen, T. Fujita, A. Hirata, M. Chen, G. Chen, B. A. Chin, Sci. Rep. 3 (2013) 1327.
13. Y. R. Wen, A. Hirata, Z. W. Zhang, T. Fujita, C. T. Liu, J. H. Jiang, M. W. Chen, Acta Mater. 61 (2013) 2133-2147.
14. T. Xi, M. B. Shahzad, D. Xu, Z. Sun, J. Zhao, C. Yang, M. Qi, K. Yang, Mater. Sci. Eng. C 71 (2017) 1079-1085.
15. T. Xi, M. B. Shahzad, D. Xu, J. Zhao, C. Yang, M. Qi, K. Yang, Mater. Sci. Eng. A 675 (2016) 243-252.
16. D. V. V. Satyanarayana, G. Malakondaiah, D. S. Sarma, Mater. Charact. 47 (2001) 61-65.
17. V. G. Pushin, N. A. Tereshchenko, R. R. Romanova, V. V. Sagaradze, A. I. Uvarov, Phys. Met. Metallogr. 57 (1984) 90-99.
18. S.-H. Kim, H. Kim, N. J. Kim, Nature 518 (2015) 77-79.
19. P. Guiraldenq, O. Hardouin Duparc, Metall. Res. Technol. 114 (2017) 613.
20. Metalary, Nickel Price (2020). https://www.metalary.com/nickel-price/(accessed 21 Mar. 2020).
21. J. A. McGurty, Austenitic Iron Alloys, U.S. Pat. No. 4,086,085A, 1978.
22. H. Kim, Scr. Mater. 160 (2019) 29-32.
23. J. Xia, Y. Noguchi, X. Xu, T. Odaira, Y. Kimura, M. Nagasako, T. Omori, R. Kainuma, Science 369 (2020) 855-858.
24. M. Piston, L. Bartlett, K. R. Limmer, D. M. Field, Metals 10 (2020) 1305.
25. G. Park, C. H. Nam, A. Zargaran, N. J. Kim, Scr. Mater. 165 (2019) 68-72.
26. Q. He, Z. Z. Zhao, J. H. Liang, J. T. Liang, D. Tang, IOP Conf. Ser. Mater. Sci. Eng. 418 (2018) 012009.
27. G. V. Raynor, V. G. Rivlin, Inst. Met. 1 Carlton House Terrace Lond. SW 1 5 DB UK 1988 (1988).
28. J. L. Murray, in: Alloy Phase Diagr., ASM International, 1992, p. 54.
29. R. Kainuma, M. Ise, K. Ishikawa, I. Ohnuma, K. Ishida, J. Alloys Compd. 269 (1998) 173-180.
30. A. J. Sedriks, P. J. Dudt, Corrosion 57 (2001) 84-91.
31. A. I. Uvarov, K. A. Malyshev, V. A. Mirmel'shtein, P. A. Ustyugov, Met. Sci. Heat Treat. 13 (1971) 836-839.
32. J. T. Busby, M. C. Hash, G. S. Was, J. Nucl. Mater. 336 (2005) 267-278.
33. K. Thompson, D. Lawrence, D. J. Larson, J. D. Olson, T. F. Kelly, B. P. Gorman, Ultramicroscopy 107 (2007) 131-139.
34. M. K. Miller, K. F. Russell, K. Thompson, R. Alvis, D. J. Larson, Microsc. Microanal. 13 (2007) 428-436.
35. T. J. Prosa, D. J. Larson, Microsc. Microanal. 23 (2017) 194-209.
36. O. C. Hellman, J. B. du Rivage, D. N. Seidman, Ultramicroscopy 95 (2003) 199-205.
37. D. Isheim, R. P. Kolli, M. E. Fine, D. N. Seidman, Scr. Mater. 55 (2006) 35-40.
38. R. P. Kolli, D. N. Seidman, Microsc. Microanal. 13 (2007) 272-284.
39. S. Vaynman, D. Isheim, R. Prakash Kolli, S. P. Bhat, D. N. Seidman, M. E. Fine, Metall. Mater. Trans. A 39 (2008) 363-373.
40. M. Kapoor, D. Isheim, G. Ghosh, S. Vaynman, M. E. Fine, Y.-W. Chung, Acta Mater. 73 (2014) 56-74.
41. X. Wang, G. Sha, Q. Shen, W. Liu, Mater. Sci. Eng. A 627 (2015) 340-347.
42. M. Kapoor, D. Isheim, S. Vaynman, M. E. Fine, Y.-W. Chung, Acta Mater. 104 (2016) 166-171.
43. Z. Wang, X. Fang, H. Li, W. Liu, Microsc. Microanal. 23 (2017) 340-349.
44. S. Chen, R. Rana, A. Haldar, R. K. Ray, Prog. Mater. Sci. 89 (2017) 345-391.
45. D. Isheim, M. S. Gagliano, M. E. Fine, D. N. Seidman, Acta Mater. 54 (2006) 841-849.
46. J. W. Bai, P. P. Liu, Y. M. Zhu, X. M. Li, C. Y. Chi, H. Y. Yu, X. S. Xie, Q. Zhan, Mater. Sci. Eng. A 584 (2013) 57-62.
47. C. T. Liu, K. S. Kumar, JOM 45 (1993) 38-44.
48. L. MUjica Roncery, S. Weber, W. Theisen, Acta Mater. 59 (2011) 6275-6286.
49. M. K. Miller, E. A. Kenik, Microsc Microanal 10 (2004) 336-341.
50. O. C. Hellman, J. Vandenbroucke, J. Rusing, D. Isheim, D. N. Seidman, Microsc. Microanal. 6 (2000) 437-444.
51. O. C. Hellman, D. N. Seidman, Mater Sci Eng A 327 (2002) 24-28.
52. J. H. Hwang, T. T. T. Trang, O. Lee, G. Park, A. Zargaran, N. J. Kim, Acta Mater. (2020) 1359645420302093.
53. Q. Chen, Z. Jin, Metall. Mater. Trans. A 26 (1995) 417-426.
54. R. Shabadi, R. Taillard, B. Radiguet, J. de Baerdemaeker, E. Leunis, Solid State Phenom. 172-174 (2011) 297-302.
55. M. K. Miller, B. D. Wirth, G. R. Odette, Mater. Sci. Eng. A A353 (2003) 133-139.
56. S. Shu, B. D. Wirth, P. B. Wells, D. D. Morgan, G. R. Odette, Acta Mater. 146 (2018) 237-252.
57. T. Philippe, M. Gruber, F. Vurpillot, D. Blavette, Microsc. Microanal. 16 (2010) 643-648.
58. S. Gao, Y. Bai, A. Shibata, N. Tsuji, IOP Conf. Ser. Mater. Sci. Eng. 219 (2017) 012020.
59. M. K. Miller, in: Kluwer Academic/Plenum Press, New York, N. Y., 2000, p. 161.
60. B. Gault, M. P. Moody, J. M. Cairney, S. P. Ringer, in: Springer, 2012, p. 135.

1. An alloy comprising:
7-30 wt. % manganese;
1-15 wt. % nickel;
1-10 wt. % aluminum;
1-8 wt. % copper;
0-15 wt. % chromium;
0-5 wt. % molybdenum;
0-3 wt. % vanadium;
0-3 wt. % titanium;
0-3 wt. % niobium;
0-2 wt. % silicon;
0-1 wt. % carbon; and
balance of iron;
wherein a majority of the iron is γ-Fe;
wherein the alloy comprises β-NiAl precipitates;
wherein at least 95 vol. % of the β-NiAl precipitates have a maximum dimension of 500 nm or less; and
wherein the alloy comprises Cu-rich precipitates comprising at least 40 at. % copper.

2. The alloy of claim 1, wherein at least 98 vol. % of the β-NiAl precipitates have a maximum dimension of 100 nm or less.

3. The alloy of claim 1, wherein the alloy comprises:
10-25 wt. % manganese;
5-15 wt. % nickel;
3-8 wt. % aluminum;
2-7 wt. % copper;
4-6 wt. % chromium;
0-5 wt. % molybdenum;
0-3 wt. % vanadium;
0-3 wt. % titanium;
0-3 wt. % niobium;
0-2 wt. % silicon;
0.1-1 wt. % carbon; and
balance of iron.

4. The alloy of claim 1, wherein the alloy comprises:
17-19 wt. % manganese;
7-11 wt. % nickel;
4-6 wt. % aluminum;
3-5 wt. % copper;
4-6 wt. % chromium;
0-5 wt. % molybdenum;
0-3 wt. % vanadium;
0-3 wt. % titanium;
0-3 wt. % niobium;
0-2 wt. % silicon;
0.1-1 wt. % carbon; and
balance of iron.

5. The alloy of claim 1;
wherein the alloy comprises M₂₃C₆;
wherein M is Mn, Cr, or Mo.

6. The alloy of claim 1, wherein the alloy has a microhardness of at least 300 HV.

7. The alloy of claim 1, wherein the alloy has a yield strength of at least 550 MPa.

8. The alloy of claim 1, wherein the alloy has a yield strength of at least 689 MPa.

9. A method comprising:
providing a mixture of elements comprising:
7-30 wt. % manganese;
1-15 wt. % nickel;
1-10 wt. % aluminum;
1-8 wt. % copper;
0-15 wt. % chromium;
0-5 wt. % molybdenum;
0-3 wt. % vanadium;
0-3 wt. % titanium;
0-3 wt. % niobium;
0-2 wt. % silicon;
0-1 wt. % carbon; and
balance of iron;
forming an alloy from the mixture;
heating the alloy to a temperature that causes formation of γ-Fe;
cooling or quenching the alloy to retain the γ-Fe at room temperature; and
ageing the alloy through one or more heat treatments to produce precipitation;
wherein a majority of the iron is γ-Fe;
wherein the method forms β-NiAl precipitates;
wherein at least 98 vol. % of the β-NiAl precipitates have a maximum dimension of 500 nm or less; and
wherein the method forms Cu-rich precipitates comprising at least 40 at. % copper.

10. The method of claim 9, wherein the mixture comprises:
10-25 wt. % manganese;
5-15 wt. % nickel;
3-8 wt. % aluminum;
2-7 wt. % copper;
4-6 wt. % chromium;
0-5 wt. % molybdenum;
0-3 wt. % vanadium;
0-3 wt. % titanium;
0-3 wt. % niobium;
0-2 wt. % silicon;
0.1-1 wt. % carbon; and
balance of iron.

11. The method of claim 9, wherein the mixture comprises:
17-19 wt. % manganese;
7-11 wt. % nickel;
4-6 wt. % aluminum;
3-5 wt. % copper;
4-6 wt. % chromium;
0-5 wt. % molybdenum;
0-3 wt. % vanadium;
0-3 wt. % titanium;
0-3 wt. % niobium;
0-2 wt. % silicon;
0.1-1 wt. % carbon; and
balance of iron.

12. The method of claim 9, wherein the β-NiAl precipitates are formed by heat treatment.
